(19) United States
(12) Patent Application Publication
(10) Pub. No.: US 2026/0088007 A1
(43) Pub. Date: Mar. 26, 2026

(54) ACOUSTIC OUTPUT SYSTEM, ACOUSTIC OUTPUT DEVICE, INFORMATION PROCESSING DEVICE, SOUND PRODUCTION METHOD, AND SOUND DATA GENERATION METHOD

(71) Applicant: CASIO COMPUTER CO., LTD., Tokyo (JP)

(72) Inventors: Makoto DANJYO, Tokyo (JP); Fumiaki OTA, Tokyo (JP); Atsushi NAKAMURA, Tokyo (JP)

(73) Assignee: CASIO COMPUTER CO., LTD., Tokyo (JP)

(21) Appl. No.: 19/334,341

(22) Filed: Sep. 19, 2025

(30) Foreign Application Priority Data
Sep. 20, 2024 (JP) 2024-163204

(51) Int. Cl. G10H 1/00

(52) U.S. Cl. CPC G10H 1/0008; G10H 2250/025; G10H 2250/455

(57) ABSTRACT

Disclosed is an acoustic output device including: an operation receiver; a communication unit; and a controller. The controller generates acoustic data in response to a performance operation on the operation receiver by a user, causes the communication unit to output the generated acoustic data to an information processing device automatically without user intervention after the performance operation, acquires sound data generated based on the outputted acoustic data in the information processing device from the communication unit automatically without user intervention after the performance operation, and causes a speaker to produce sound based on the acquired sound data automatically without user intervention after the performance operation.

### CROSS-REFERENCE TO RELATED APPLICATIONS

This application claims priority to Japanese Patent Application No. 2024-163204 filed on Sep. 20, 2024 and incorporates by reference the entire specification, claims, abstract and drawings.

### BACKGROUND OF INVENTION

### Technical Field

The present disclosure relates to an acoustic output system, an acoustic output device, an information processing device, a sound production method, and a sound data generation method.

### Description of Related Art

The electronic musical instrument of Japanese Patent No. 6835182 generates and outputs singing voice sound output data based on musical sound output data (excitation source signal) for vocal sound source generated and output by sound source LSI based on user's performance operation.

### SUMMARY OF THE INVENTION

The acoustic output device according to an aspect of the present disclosure is an acoustic output device comprising:
an operation receiver;
a communication unit; and
a controller, wherein the controller
generates acoustic data in response to a performance operation on the operation receiver by a user,
causes the communication unit to output the generated acoustic data to an information processing device automatically without user intervention after the performance operation,
acquires sound data generated based on the outputted acoustic data in the information processing device from the communication unit automatically without user intervention after the performance operation, and
causes a speaker to produce sound based on the acquired sound data automatically without user intervention after the performance operation.

### BRIEF DESCRIPTION OF DRAWINGS

FIG. 1 shows an example of the overall configuration of an electronic musical instrument system of the present disclosure.

FIG. 2 is a block diagram showing the functional configuration of the electronic musical instrument shown in FIG. 1.

FIG. 3 illustrates sound changes caused by operation on performance operation receivers of the electronic musical instrument shown in FIG. 1.

FIG. 4 is a block diagram showing the functional configuration of the terminal device in FIG. 1.

FIG. 5 is a flowchart showing the flow of external waveform input process executed by the CPU in FIG. 4.

FIG. 6 is a flowchart showing the flow of Note On/Off event generation process in FIG. 5.

FIG. 7 is a graph plotting in time series envelope data generated by the Note On/Off event generation process.

FIG. 8 is a flowchart showing the flow of acoustic data processing process shown in FIG. 5.

FIG. 9 is a flowchart showing the flow of singing voice generation process executed by the CPU in FIG. 4.

FIG. 10 schematically illustrates the flow from performance operation of the electronic musical instrument to production of a singing voice by the electronic musical instrument in the embodiment.

### DETAILED DESCRIPTION

The electronic musical instrument of Japanese Patent No. 6835182 cannot make its electronic musical instrument produce (emit) sound based on the waveform data (called acoustic data) of the musical sound output from the speaker of the electronic musical instrument.

In the present disclosure, based on acoustic data output from an acoustic output device, that acoustic output device is made to produce sound.

According to the present disclosure, based on acoustic data output from an acoustic output device, it is possible to make that acoustic output device produce sound.

Hereinafter, embodiments for implementing the present invention will be described using drawings. However, the embodiments described below are subject to various technically preferred limitations for implementing the present invention.

Therefore, the technical scope of the present invention is not limited to the following embodiments and illustrated examples.

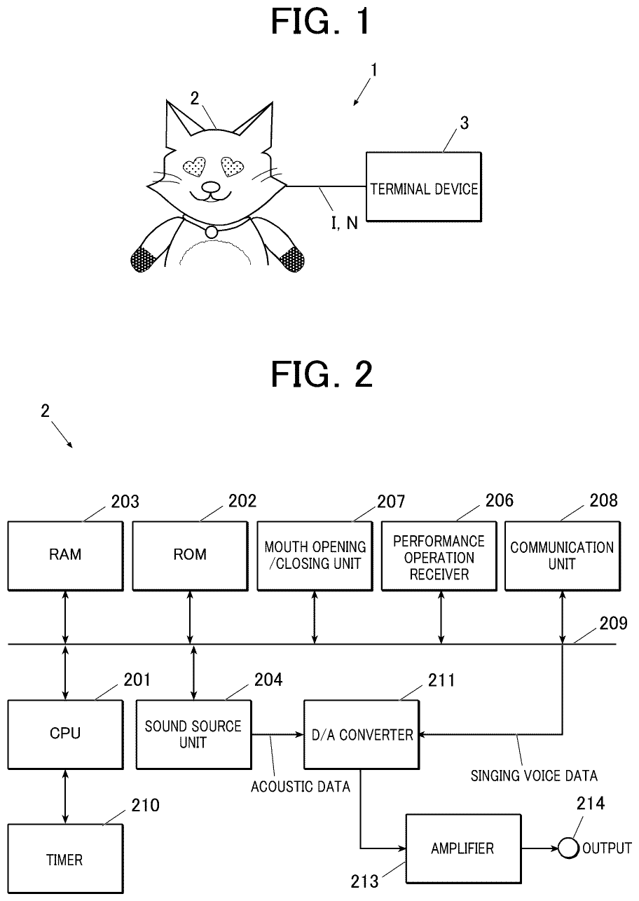

As shown in FIG. 1, the electronic musical instrument system 1 (acoustic output system) according to the embodiment is configured by including an electronic musical instrument 2 (acoustic output device) and a terminal device 3 (information processing device), connected via a communication interface I (or a communication network N).

The electronic musical instrument 2 includes a performance operation receiver 206, generates acoustic data (which may be expressed as an excitation source) in response to the user's operation on the performance operation receiver 206, and produces (outputs) musical sounds based on the generated acoustic data. In a state in which the electronic musical instrument 2 is connected to the terminal device 3 via the communication interface I (or the communication network N), when the performance operation receiver 206 is operated by the user, the electronic musical instrument 2 generates acoustic data in response to the operation on the performance operation receiver 206 and outputs the generated acoustic data to the terminal device 3. When sound data (which may be expressed as singing voice data) is output from the terminal device 3 in response to the output of the acoustic data, the electronic musical instrument 2 acquires the sound data and produces a singing voice (sound) based on the acquired sound data. The present proposed acoustic data is not MIDI data. In other words, the present proposed acoustic data does not include MIDI data, which is a data format of “commands” for software sound sources, and the like to reproduce sounds. The present proposed acoustic data is audio data. In other words, the present proposed acoustic data is waveform data obtained when external sound is acquired from a microphone. If this proposal is not used, the electronic musical instrument 2 does not produce musical sounds according to the lyrics. When using this proposal, the electronic musical instrument 2 produces musical sounds according to the lyrics. In this respect, the proposal improves the functionality of the computer of the electronic musical instrument 2. The present proposed terminal device 3 generates sound data by synthesizing parameters output by a learned model 302b into acoustic data output by the electronic musical instrument 2, and outputs the generated sound data to the electronic musical instrument 2. This reduces the processing load on the computer of the electronic musical instrument 2. In this respect, the proposal improves the functionality of the computer of the electronic musical instrument 2.

As shown in FIG. 1, in the embodiment, the electronic musical instrument 2 is a cat-shaped acoustic output device, but the proposed acoustic output device includes electronic musical instruments, electronic toys, electronic string instruments, electronic wind instruments, electronic percussion instruments, and the like.

FIG. 2 is a block diagram showing the functional configuration of the control system of the electronic musical instrument 2 in FIG. 1. As shown in FIG. 2, the electronic musical instrument 2 is configured by including a CPU (Central Processing Unit) 201 connected to a timer 210, a ROM (Read Only Memory) 202, a RAM (Random Access Memory) 203, a sound source unit 204, a performance operation receiver 206, a mouth opening/closing unit 207, and a communication unit 208, which are each connected to the bus 209. The sound source unit 204 is connected to a D/A converter 211, and acoustic data, which is the waveform data of musical sounds output from the sound source unit 204, is converted into analog signals by a D/A converter 211, amplified by an amplifier 213, and then output from a speaker 214 as musical sounds such as instrument sounds. The sound data (singing voice waveform data) from the terminal device 3 acquired by the communication unit 208 is converted into analog signals by the D/A converter 211, amplified by the amplifier 213, and then output from the speaker 214 as singing voices.

The CPU 201 as a controller is a processor that executes the control operation of the electronic musical instrument 2 in FIG. 1 by executing a program stored in the ROM 202 while using the RAM 203 as a work memory. The CPU 201 may consist of a plurality of CPUs. In this case, the plurality of CPUs may be involved in a common process, or they may independently execute different processes in parallel.

For example, when the performance operation receiver 206 is operated, the CPU 201 causes the sound source unit 204 to generate acoustic data in response to the operation on the performance operation receiver 206, and causes musical sounds based on the generated acoustic data to be output by the speaker 214 via the D/A converter 211 and the amplifier 213.

When the performance operation receiver 206 is operated while connected to the terminal device 3 via the communication unit 208, the CPU 201 causes the sound source unit 204 to generate acoustic data in response to the operation on the performance operation receiver 206 and outputs the generated acoustic data to the terminal device 3 via the communication unit 208. When sound data generated based on the acoustic data at the terminal device 3 is acquired by the communication unit 208, the CPU 201 causes the singing voice to be produced based on the acquired sound data. In other words, the CPU 301 causes the singing voice based on the acquired sound data to be output via the D/A converter 211 and the amplifier 213 and by the speaker 214.

The ROM 202 stores programs, various fixed data, and the like. The RAM 203 is a volatile semiconductor memory that forms a work area for temporarily storing various data and programs.

The sound source unit 204 has a waveform ROM in which acoustic data for producing musical sounds is stored. Here, the musical sound is a musical sound with a tone that is produced by the electronic musical instrument 2 in response to the operation on the performance operation receiver 206. The sound source unit 204 reads acoustic data from the waveform ROM (not shown), for example, based on pitch information and volume information (velocity value) according to the operation on the performance operation receiver 206, in accordance with control instructions from the CPU 201, and outputs the data to the D/A converter 211. The sound source unit 204 is not limited to the PCM (Pulse Code Modulation) sound source system, but may also use other sound source systems, such as FM (Frequency Modulation) sound source systems, for example.

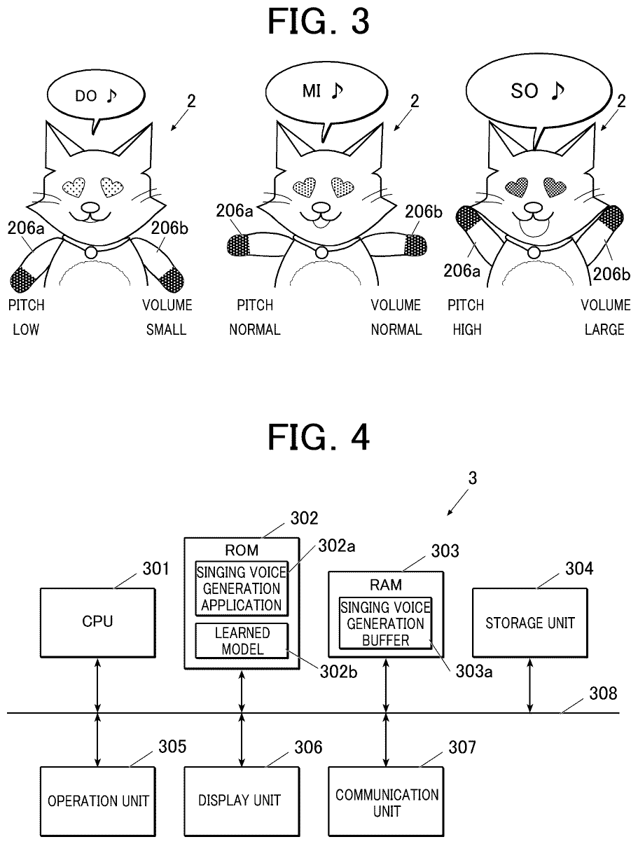

The performance operation receiver 206 is used by the user to control the pitch and volume (velocity value). The performance operation receiver 206 has a performance operation receiver 206a for controlling the pitch and a performance operation receiver 206b for controlling the volume, as shown in FIG. 3. In the embodiment, the right hand of the cat of the electronic musical instrument 2 is the performance operation receiver 206a for controlling the pitch, and the left hand is the performance operation receiver 206b for controlling the volume.

For example, when the user changes the height of the right hand while touching the right hand of the cat of the electronic musical instrument 2, the performance operation receiver 206a outputs a detection signal of the right hand height to the CPU 201. The CPU 201 outputs pitch information according to the detection signal from the performance operation receiver 206a to the sound source unit 204. For example, as shown in FIG. 3, when it is detected that the right hand is set at the lowest position, the pitch information of the lowest note (for example, Do) that can be output by the electronic musical instrument 2 is output, and the pitch is increased as the right hand position is raised. When it is detected that the right hand is set at the highest position, the highest pitch information (for example, So) that can be output by the electronic musical instrument 2 is output.

For example, if the user changes the height of the left hand while touching the left hand of the cat of the electronic musical instrument 2, the performance operation receiver 206b outputs a detection signal of the left hand height to the CPU 201. The CPU 201 outputs volume information according to the detection signal from the performance operation receiver 206b to the sound source unit 204. For example, as shown in FIG. 3, when the left hand is set at the lowest position, the volume information of the lowest volume sound that can be output by the electronic musical instrument 2 is output, the volume increases as the left hand position becomes higher, and when the left hand is set at the highest position, the volume information of the loudest sound that can be output by the electronic musical instrument 2 is output.

The mouth opening/closing unit 207 has a mechanism that opens and closes the mouth of the cat of the electronic musical instrument 2 based on control from the CPU 201.

The communication unit 208 transmits and receives data to and from external devices such as the terminal device 3 connected via the communication interface I such as a USB (Universal Serial Bus) cable or the communication network N such as the Internet.

The terminal device 3 acquires the acoustic data output from the electronic musical instrument 2 by the communication unit 307, synthesizes spectral parameters (which may be expressed as spectral envelopes or acoustic feature amounts) to the acquired acoustic data to generate sound data, and outputs the generated sound data to the electronic musical instrument 2.

As shown in FIG. 4, the terminal device 3 is a computer including a CPU 301, a ROM 302, a RAM 303, a storage unit 304, an operation unit 305, a display unit 306, a communication unit 307, and the like, and each unit is connected by a bus 308. For example, tablet PCs (Personal Computers), notebook PCs, smartphones, and the like are applicable as the terminal device 3.

The CPU 301 as a controller is a processor that controls the operation of each unit of the terminal device 3 by reading and executing various programs, including a singing voice generation application 302a stored in the ROM 302, while using the RAM 303 as a work memory. The CPU 301 may consist of a plurality of CPUs. In this case, the plurality of CPUs may be involved in a common process, or they may independently execute different processes in parallel.

The ROM 302 is a non-transitory storage medium readable by the CPU 301 as a computer and stores various data including the singing voice generation application 302a and the learned model 302b. The singing voice generation application 302a is an application program for the CPU 301 to perform the singing voice generation function described below. The learned model 302b is generated by machine learning a plurality of data sets consisting of score data (lyrics data (lyrics text information) and pitch data (including note length information)) of a plurality of sung songs and sound data of a singer singing each sung song. When lyrics data and pitch data of any sung song (or phrase) are input, the learned model 302b infers a group of singing voice parameters (called singing voice information) to produce a singing voice equivalent to the case of the input song being sung by the singer when the learned model 302b was generated. The pitch data to be input to the learned model 302b may be tailored to the sung song or may be fixed values. If it is a fixed value, for example, it is preferable that the fixed value is C3, the reference sound, or E4 for a female voice.

The RAM 303 is a volatile semiconductor memory that forms a work area for temporarily storing various data and programs. In this embodiment, the RAM 303 forms, for example, a singing voice generation buffer 303a used by the singing voice generation application 302a.

The storage unit 304 is composed of a nonvolatile semiconductor memory, HDD (Hard Disk Drive) or the like, and stores various data. The singing voice generation application 302a and the learned model 302b may be stored in the storage unit 304.

The operation unit 305 consists of pushbutton switches and a touch panel attached to the display unit 306. The operation unit 305 detects pushbutton switch operations and on-screen touch operations by the user and outputs operation signals to the CPU 301.

The display unit 306 is composed of an LCD (Liquid Crystal Display), EL (Electro Luminescence) display, or the like, and performs various displays according to the display information instructed by the CPU 301.

The communication unit 307 transmits and receives data to and from external devices such as s the electronic musical instruments 2 connected via the communication interface I such as a USB (Universal Serial Bus) cable or the communication network N such as the Internet.

The operation of the electronic musical instrument system 1 is described next. In the terminal device 3, when the generation of singing voice parameters is instructed by the operation unit 305 and lyrics data and pitch data of any sung song (or phrase, hereinafter the same) that is desired to be produced on the electronic musical instrument 2 are input via the communication unit 307, or the like, the CPU 301 causes the learned model 302b to generate the singing voice information. In other words, the CPU 301 inputs the input lyrics data and pitch data to the learned model 302b, causes the learned model 302b to infer a group of singing voice parameters, and stores the singing voice information, which is the inferred group of singing voice parameters, in the storage unit 304. The lyrics data and pitch data may be stored in advance in the storage unit 304. Accompaniment data (sound waveform data of accompaniment) corresponding to lyrics data and pitch data may be stored in storage unit 304 in association with the lyrics data and pitch data.

Here, the singing voice information is explained. Each segment of a sung song separated by a predetermined time unit in the time direction is called a frame, and the learned model 302b generates singing voice parameters for each frame. In other words, the singing voice information of a single sung song generated by the learned model 302b is composed of a plurality of singing voice parameters (a group of time-series singing voice parameters) in frame units. The singing voice parameters in frame units include spectral parameters (frequency spectral envelopes of the voice to be produced) and fundamental frequency F0 parameters (base pitch frequencies of the voice to be produced, which may be expressed as the excitation source).

When the terminal device 3 is instructed to generate sound data by operating the operation unit 305, the CPU 301 starts the singing voice generation application 302a and executes the following process.

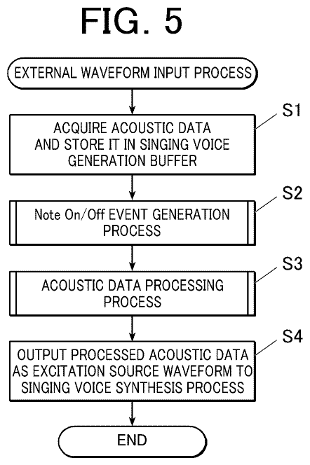

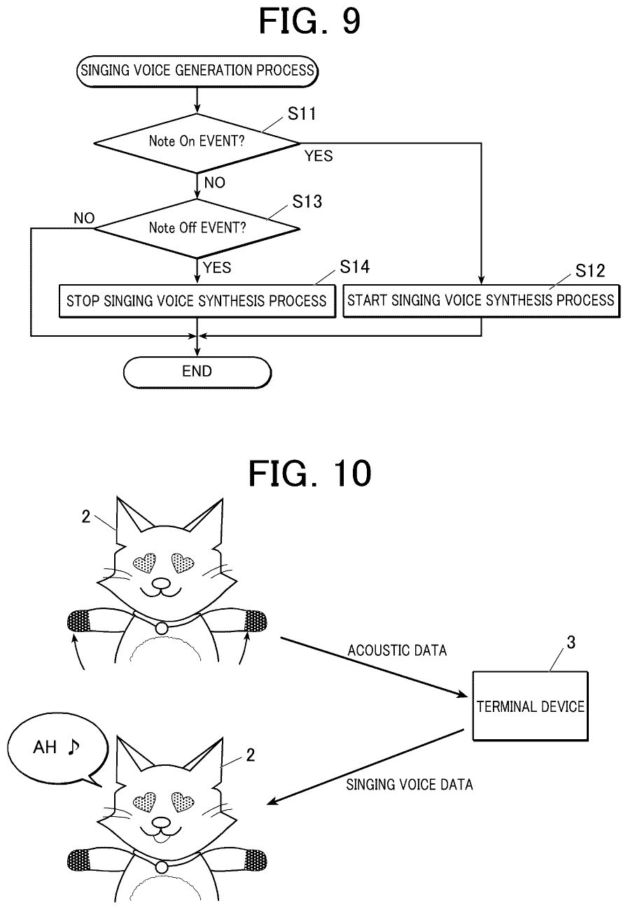

First, the CPU 301 initializes the buffer used by the singing voice generation application 302a (singing voice generation buffer 303a), various variables (previous average amplitude value, i), flag (Note On Flag), array, parameters, and the like. The CPU 301 allows the user to select any sung song that he/she wants the electronic musical instrument 2 to produce from among the songs for which the singing voice information is stored in the storage unit 304, and reads the singing voice information of the selected song into the RAM 303. The CPU 301 also notifies the user to connect the electronic musical instrument 2 by, for example, displaying a message such as “Please connect the electronic musical instrument 2” on the display unit 306. The CPU 301 executes the external waveform input process shown in FIG. 5 and the singing voice generation process shown in FIG. 9 every predetermined cycle (at predetermined time intervals) while the singing voice generation application 302a is running.

The user connects the electronic musical instrument 2 to the terminal device 3 for communication and makes performance of the electronic musical instrument 2. In other words, the user performs performance operations of the cat-shaped electronic musical instrument 2 by raising or lowering the hands, which are the performance operation receivers 206a and 206b, as shown in FIG. 3. The CPU 201 of the electronic musical instrument 2 causes the sound source unit 204 to generate acoustic data in response to the operations on the performance operation receivers 206a and 206b, and transmits the acoustic data to the terminal device 3 by the communication unit 208.

By executing the external waveform input process shown in FIG. 5 at each predetermined cycle, the CPU 301 of the terminal device 3 generates a Note On event or Note Off event, which triggers sound data generation in the singing voice generation process described below, based on the acoustic data output from the electronic musical instrument 2, or optimizes the acoustic data as the excitation source waveform data for the singing voice.

In the external waveform input process, first, the CPU 301 acquires the acoustic data output from the electronic musical instrument 2 and acquired by the communication unit 307 for the amount of size of the singing voice generation buffer 303a and stores it in the singing voice generation buffer 303a (step S1).

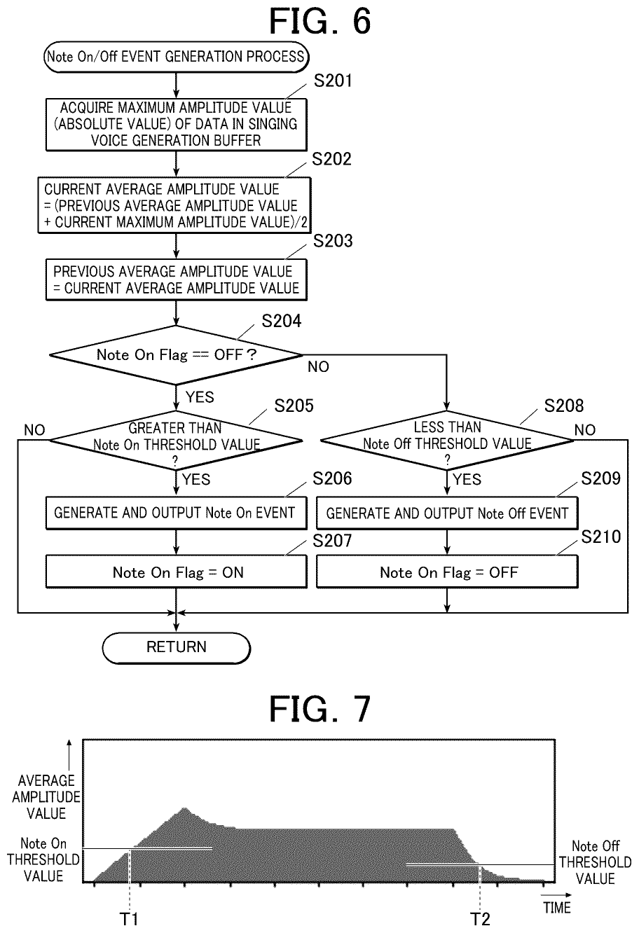

Next, the CPU 301 executes Note On/Off event generation process (step S2). As shown in FIG. 6, in the Note On/Off event generation process, the CPU 301 first acquires the maximum amplitude value (absolute value) of the acoustic data in the singing voice generation buffer 303a (step S201).

Next, the CPU 301 calculates the current average amplitude value (step S202). The current average amplitude value can be calculated by the following (Equation 1). The previous average amplitude value is a variable set in step S203, described below, and its initial value is 0. The envelope data is generated by the following (Equation 1).

Current average amplitude value=(previous average amplitude value+current maximum amplitude value)/2 (Equation 1)

In the embodiment, the envelope data is generated by a moving average of the maximum amplitude values, but the method of generating envelope data is not limited to this. For example, envelope data may be generated by inverse Fourier transforming the signal acquired by Fourier transforming (FFT) the input acoustic data with a Hilbert transform (multiplication by 90 degrees phase shift). For optimization of Note On/Note Off timing, the envelope data generation method may be changed when generating Note On events and when generating Note Off events.

Next, the CPU 301 sets the current average amplitude value to the previous average amplitude value (variable) (step S203).

Next, the CPU 301 determines whether or not Note On Flag is set to OFF (step S204). Note On Flag is set to On when a Note On event is generated and is set to OFF when a Note Off event is generated. The initial value is set to OFF.

If it is determined that Note On Flag is set to OFF (step S204; YES), the CPU 301 determines whether or not the current average amplitude value, which is envelope data, is greater than the preset Note On threshold value (first threshold value) (step S205). If the current average amplitude value is determined to be equal to or less than the preset Note On threshold value (step S205; NO), the CPU 301 moves to step S3 in FIG. 5.

If the current average amplitude value is determined to be greater than the preset Note On threshold value (step S205; YES), the CPU 301 generates a Note On event and outputs it to the singing voice generation process (step S206). The CPU 301 then sets Note On Flag to On (step S207) and moves to step S3 in FIG. 5. The Note On event is an event (note-on data) indicating that a performance operation (Note On) has been performed on the electronic musical instrument 2.

On the other hand, if it is determined in step S204 that Note On Flag is not set to OFF (set to ON) (step S204; NO), the CPU 301 determines whether or not the current average amplitude value is less than the preset Note Off threshold value (second threshold value) (step S208), where Note On threshold value>Note Off threshold value.

If the current average amplitude value is determined to be greater than or equal to the preset Note Off threshold value (step S208; NO), the CPU 301 moves to step S3 in FIG. 5.

If the current average amplitude value is determined to be less than the preset Note Off threshold value (step S208; YES), the CPU 301 generates a Note Off event and outputs it to the singing voice generation process (step S209). The CPU 301 then sets Note On Flag to Off (step S210) and moves to step S3 in FIG. 5. The Note On event is an event (note-off data) indicating that the performance operation has been released (Note Off) on the electronic musical instrument 2.

FIG. 7 is a time-series plotted graph of the envelope data (current average amplitude value) generated by the Note On/Off event generation process. The Note On event is generated at time T1 and the Note Off event at time T2 shown in FIG. 7.

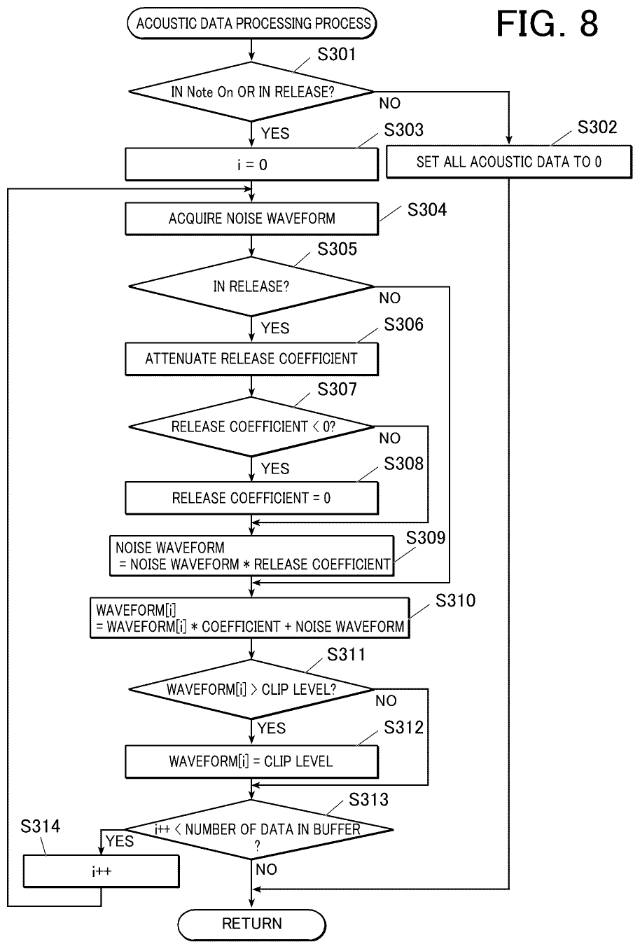

Returning to FIG. 5, in step S3, the CPU 301 executes the acoustic data processing process (step S3). As shown in FIG. 8, in the acoustic data processing process, the CPU 301 first determines whether or not the electronic musical instrument 2 is in Note On or in release (step S301). The CPU 301 determines that the electronic musical instrument 2 is in Note On when a Note On event has been generated and a Note Off event has not yet been generated (when Note On Flag is set to On). The CPU 301 determines that the electronic instrument 2 is in release when the acoustic data value has not yet reached 0 after the Note Off event is generated.

If it is determined that the electronic musical instrument 2 is not in Note On or in release (step S301; NO), the CPU 301 sets the value of all acoustic data stored in singing voice generation buffer 303a to 0 (step S302) and moves to step S4 in FIG. 5.

If it is determined that the electronic musical instrument 2 is in Note On or in release (step S301; YES), the CPU 301 sets 0 to variable i (step S303) and acquires noise waveform (noise data) (step S304). The noise waveform can be a PCM (Pulse Code Modulation) waveform of a predetermined length, such as an actual silent noise waveform, white noise, or pink noise waveform. The noise waveform data is stored in advance, for example, in the ROM 302 or the storage unit 304.

Next, the CPU 301 determines whether or not the electronic musical instrument 2 is in release (step S305). If it is determined that the electronic musical instrument 2 is not in release (step S305; NO), the CPU 301 moves to step S310.

If the electronic musical instrument 2 is determined to be in release (step S305; YES), the CPU 301 reduces the release coefficient (step S306). The release coefficient is a factor used to attenuate the noise waveform in release. For example, the CPU 301 takes the initial value of the release coefficient as 100/100 and reduces it by 2/100.

Next, the CPU 301 determines whether or not release coefficient <0 is satisfied (step S307). If it is determined that release coefficient <0 is satisfied (step S307; YES), the CPU 301 sets the release coefficient to 0 (step S308) and moves to step S309. If it is determined that release coefficient <0 is not satisfied (step S307; NO), the CPU 301 moves to step S309.

In step S309, the CPU 301 multiplies the noise waveform value by the release coefficient and sets the obtained value as the noise waveform (step S309) and moves to step S310.

In step S310, the CPU 301 multiplies the value of waveform [i] (amplitude value) by the amplification coefficient and adds the noise coefficient to set the obtained value as the value of waveform [i] (step S310). Waveform [i] is the i-th acoustic data from the beginning among the acoustic data in the singing voice generation buffer 303a. The amplification coefficient is a factor to amplify the value of waveform [i]. In other words, amplification coefficient >1. Since the production of consonants contains noise components, the noise coefficient can be added to the waveform [i] to make it closer to the production of a singing voice. The amplification coefficient may be predetermined, or it may be varied based on the maximum amplitude value to obtain as constant a distortion as possible.

Next, the CPU 301 determines whether or not waveform [i]>clip level is satisfied (step S311). The clip level is a predetermined upper limit for the amplitude value of waveform [i]. If it is determined that waveform [i]>clip level is satisfied (step S311; YES), the CPU 301 replaces the value of waveform [i] with the clip level (that is, the upper limit value) (step S312) and moves to step S313. In other words, if waveform [i]>clip level is satisfied, the value of waveform [i] is clipped to the clip level (that is, the upper limit). The process of steps S311-S312 can increase overtones in the acoustic data, making the acoustic data closer to waveform data with the characteristics of vocal cords. If it is determined that waveform [i]>clip level is not satisfied (the value of waveform [i] is equal to or below the clip level) (step S311; YES), the CPU 301 moves to step S313.

In the above example, the process of amplifying and clipping the acoustic data was raised as a processing process to make the acoustic data closer to the waveform the data having characteristics of vocal cords, but the content of the processing process is not limited to this. For example, acoustic data and pre-prepared vocal waveform data may each be Fourier transformed (FFT), and then inverse Fourier transformed, after the process to approximate the values of the Fourier transformed acoustic data and the Fourier transformed sound waveform data.

In step S313, the CPU 301 determines whether or not the incremented value of i is smaller than the number of data in the singing voice generation buffer 303a (step S313). If it is determined that the incremented value of i is smaller than the number of data in the singing voice generation buffer 303a (step S313; YES), the CPU 301 increments i (step S314) and returns to step S304. The CPU 301 repeats steps S304 to S314 until it determines that the incremented value of i is greater than or equal to the number of data in the buffer. By the processes in steps S304-S314, the CPU 301 can optimize the acoustic data as the excitation source of the singing voice.

In step S313, if the CPU 301 determines that the value of i incremented is greater than or equal to the number of data in the buffer (step S313; NO), the CPU 301 moves to step S4 in FIG. 5.

In step S4 of FIG. 5, the CPU 301 outputs the processed acoustic data as excitation source waveform data to the singing voice synthesis process (step S4) and ends the external waveform input process.

The CPU 301 of the terminal device 3 executes the singing voice generation process shown in FIG. 9 at each predetermined cycle. The singing voice generation process starts the singing voice synthesis process when the Note On event is generated in the external waveform input process and stops the singing voice synthesis process when the Note Off event is generated.

In the singing voice generation process, the CPU 301 first determines whether or not a Note On event has been generated (step S11).

If it is determined that a Note On event has been generated (step S11; YES), the CPU 301 starts the singing voice synthesis process (step S12) and ends the singing voice generation process. The singing voice synthesis process synthesizes the acoustic data (excitation source waveform data) output from the external waveform input process with the spectral parameters of the singing voice information stored in the storage unit 304 to generate sound data, and outputs (transmits) the generated sound data to the electronic musical instrument 2 by the communication unit 307. When the CPU 301 outputs (transmits) sound data to the electronic musical instrument 2 by the communication unit 307 in the singing voice synthesis process, it may also output the corresponding accompaniment data to the electronic musical instrument 2.

If it is determined that a Note On event has not been generated (step S11; NO), the CPU 301 determines whether or not a Note Off event has been generated (step S13). If it is determined that a Note Off event has not been generated (step S13; NO), the CPU 301 ends the singing voice generation process. If it is determined that a Note Off event has been generated (step S13; YES), the CPU 301 stops the singing voice synthesis process (step S14) and ends the singing voice generation process.

In the above electronic musical instrument system 1, as shown in FIG. 10, when the hand part of the cat-shaped electronic musical instrument 2 is raised and lowered by the user to perform a performance operation, acoustic data corresponding to the performance operation is automatically output to the terminal device 3 without user intervention after the performance operation. The terminal device 3 automatically synthesizes the acoustic data from the electronic musical instrument 2 and the spectral parameters generated by the learned model 302b without user intervention after the performance operation to generate sound data, which is output to the electronic musical instrument 2. The electronic musical instrument 2 automatically outputs the singing voice based on the sound data received from the terminal device 3 from the speaker 214 without user intervention after the performance operation. At this time, the CPU 201 of the electronic musical instrument 2 opens and closes the mouth opening/closing unit 207 in accordance with the output of the singing voice. In other words, when the user performs the performance operation on the electronic musical instrument 2, the cat's mouth of the electronic musical instrument 2 moves in response to the performance operation to produce the singing voice (sing a song). Thus, the user can enjoy the singing voice output from the electronic musical instrument 2 by performing the performance operation on the electronic musical instrument 2.

As explained above, the electronic musical instrument system 1 includes an electronic musical instrument 2 and a terminal device 3. The electronic musical instrument 2 generates acoustic data in response to user operation and outputs the generated acoustic data to the terminal device 3. The terminal device 3 synthesizes spectral parameters into the acoustic data output from the electronic musical instrument 2 to generate sound data, and outputs the generated sound data to the electronic musical instrument 2. The electronic musical instrument 2 produces a singing voice based on the sound data output from the terminal device 3.

Therefore, the electronic musical instrument system 1 can make the electronic musical instrument 2 produce the singing voice based on the acoustic data output from the electronic musical instrument 2. In other words, the advantage is that the electronic musical instrument 2, which does not have a function to generate sound data based on user's performance operation, can be made to produce the singing voice based on the performance operation. The user can enjoy having the electronic musical instrument 2 produce the singing voice by performing the performance operation.

The CPU 301 of the terminal device 3 generates note-on data based on the acoustic data output from the electronic musical instrument 2, indicating that a performance operation was performed on the electronic musical instrument 2, and generates sound data based on the generated note-on data. For example, the CPU 301 generates envelope data from the acoustic data, generates note-on data when the generated envelope data reaches the first threshold value, and generates sound data based on the generated note-on data. Therefore, it is possible to detect the note-on timing (performance operation timing) from the acoustic data, which is a waveform, and have the electronic musical instrument 2 produce the singing voice at the timing corresponding to the performance operation.

When the envelope data generated from the acoustic data falls below the second threshold value, which is smaller than the first threshold value, the CPU 301 of the terminal device 3 generates note-off data indicating that the performance operation has been released on the electronic musical instrument 2, and stops generating sound data based on the generated note-off data. Therefore, the timing of note-off (timing when the performance operation is released) can be detected from the acoustic data, which is a waveform, and it is possible to make the electronic musical instrument 2 mute the singing voice at a timing corresponding to the performance operation.

The description in the above embodiment is a suitable example of the acoustic output system, acoustic output device, information processing device, sound production method, and sound data generation method of the present disclosure, and is not limited thereto.

For example, the output level of a singing voice based on the generated sound data may be controlled by calculating a velocity value based on the acoustic data and multiplying the sound data by the calculated velocity value as a coefficient. For example, the CPU 301 calculates the difference value between the current average amplitude value of the acoustic data and the previous average amplitude value, and calculates the velocity value based on the calculated difference value. The sound data is then multiplied by the coefficient based on the calculated velocity value and output to the speaker 214. The velocity value can be calculated, for example, by the following (Equation 2). Velocity value=MAX value of velocity value×difference value/MAX value of difference value . . . (Equation 2). Also, a conversion table that defines the relationship between the difference value and the velocity value can be stored in the storage unit 304 in advance, and the velocity value can be derived from the difference value based on the conversion table.

For example, the above embodiment discloses an example in which a semiconductor memory such as a ROM or a hard disk is used as a computer-readable medium for the program, but the computer-readable medium is not limited to this example. As other computer-readable media, SSDs and portable recording media such as CD-ROMs can be applied. Carrier wave is also applicable as a medium to provide program data via communication lines.

Although the embodiments of the present invention have been described above, the technical scope of the present invention is not limited to the embodiments described above, but is defined based on the claims. Furthermore, the technical scope of the present invention includes an equal range of changes made from the claims that are unrelated to the essence of the present invention.

1. An acoustic output device comprising:
an operation receiver;
a communication unit; and
a controller, wherein the controller
generates acoustic data in response to a performance operation on the operation receiver by a user,
causes the communication unit to output the generated acoustic data to an information processing device automatically without user intervention after the performance operation,
acquires sound data generated based on the outputted acoustic data in the information processing device from the communication unit automatically without user intervention after the performance operation, and
causes a speaker to produce sound based on the acquired sound data automatically without user intervention after the performance operation.

2. An information processing device comprising a controller that
causes a communication unit to acquire acoustic data that is generated by an acoustic output device in response to a performance operation on the acoustic output device by a user and output by the acoustic output device automatically without user intervention after the performance operation,
generates sound data by synthesizing a spectral parameter to the acquired acoustic data automatically without user intervention, and
causes the communication unit to output the generated sound data to the acoustic output device automatically without user intervention.

3. The information processing device according to claim 2, wherein the controller generates note-on data indicating that a performance operation has been performed on the acoustic output device based on the acoustic data, and generates the sound data based on the generated note-on data.

4. The information processing device according to claim 3, wherein the controller generates envelope data from the acoustic data and generates the note-on data when the generated envelope data reaches a first threshold value.

5. The information processing device according to claim 4, wherein when the envelope data falls below a second threshold value, which is smaller than the first threshold value, the controller generates note-off data indicating that a performance operation has been released on the acoustic output device and stops generating the sound data based on the generated note-off data.

6. A sound production method in an acoustic output device including an operation receiver, a speaker, and a controller, the method comprising:
generating, by the controller, acoustic data in response to a performance operation on the operation receiver by a user;
causing, by the controller, a communication unit to output the generated acoustic data to an information processing device automatically without user intervention after the performance operation;
acquiring, by the controller, sound data generated based on the acoustic data in the information processing device from the communication unit automatically without user intervention after the performance operation; and
causing, by the controller, the speaker to produce sound based on the acquired sound data automatically without user intervention after the performance operation.

7. A sound data generation method in an information processing device including a controller, the method comprising:
causing, by the controller, a communication unit to acquire acoustic data that is generated by an acoustic output device in response to a performance operation on the acoustic output device by a user and output by the acoustic output device automatically without user intervention after the performance operation;
generating, by the controller, sound data by synthesizing a spectral parameter to the acquired acoustic data automatically without user intervention; and
causing, by the controller, the communication unit to output the generated sound data to the acoustic output device automatically without user intervention.

8. The sound data generation method according to claim 7, wherein the controller generates note-on data indicating that a performance operation has been performed on the acoustic output device based on the acoustic data, and generates the sound data based on the generated note-on data.

9. The sound data generation method according to claim 8, wherein the controller generates envelope data from the acoustic data and generates the note-on data when the generated envelope data reaches a first threshold value.

10. The sound data generation method according to claim 9, wherein when the envelope data falls below a second threshold value, which is smaller than the first threshold value, the controller generates note-off data indicating that a performance operation has been released on the acoustic output device and stops generating the sound data based on the generated note-off data.

11. An acoustic output system comprising:
an acoustic output device comprising:
an operation receiver;
a communication unit;
a controller, wherein the controller:
generates acoustic data in response to a performance operation on the operation receiver by a user,
causes the communication unit to output the generated acoustic data to an information processing device automatically without user intervention after the performance operation,
acquires sound data generated based on the outputted acoustic data in the information processing device from the communication unit automatically without user intervention after the performance operation, and
causes a speaker to produce sound based on the acquired sound data automatically without user intervention after the performance operation; and
the information processing device according to claim 2.

12. A sound production method in an acoustic output system comprising:
an acoustic output device comprising:
an operation receiver;
a communication unit; and
a controller, wherein the controller:
generates acoustic data in response to a performance operation on the operation receiver by a user,
causes the communication unit to output the generated acoustic data to an information processing device automatically without user intervention after the performance operation,
acquires sound data generated based on the outputted acoustic data in the information processing device from the communication unit automatically without user intervention after the performance operation, and
causes a speaker to produce sound based on the acquired sound data automatically without user intervention after the performance operation; and
a sound production method in the information processing device according to claim 2.
